(19) United States
(12) Patent Application Publication
(10) Pub. No.: US 2006/0107610 A1
(43) Pub. Date: May 25, 2006

(54) Methods for making composite tiles

(76) Inventor: Brian Augustine Boserio, Whumbal (AU)

Correspondence Address: David P Dureska;Buckingham Doolittle & Burroughs, 4518 Fulton Drive NW, PO Box 35548, Canton, OH, 44735-5548, US

(21) Appl. No.: 10/530,609

(22) PCT Filed: Oct. 10, 2003
(86) PCT No.: PCT/AU03/01345

§ 371 Date: Oct. 19, 2005

(30) Foreign Application Priority Data
Oct. 10, 2002 (AU) 2002952043

(51) Int. Cl. B29C 39/10; B32B 37/00

(52) U.S. Cl. 52/315; 264/261; 264/279

(57) ABSTRACT

A decorative paving tile or panel comprises a plurality of irregularly shaped stone elements of the same or differing thickness embedded in a backing layer or base to form a tile or panel of the predetermined thickness wherein the normally exposed surfaces of said stone elements lie in a plane substantially parallel to a mounting surface of said backing layer or base. A flowable displacement material may be employed in the interstices between-adjacent stone elements and/or a boundary wall of a tile or panel mould to forma grouting channel. An irregular space between adjacent stone elements of adjacent tiles or panels allows the formation of an optically seamless tiled or panelled surface when grouted.

### FIELD OF THE INVENTION

This invention relates to methods for making composite tiles.

### BACKGROUND OF THE INVENTION

A traditional method of laying tiles, slate or the like (from hereon referred to as “stone elements”) entails spreading mortar over a surface to which the stone elements are to be applied and then pressing each stone element into the mortar by hand. This paving system is typically known as “crazy paving” where the stone elements have irregular shapes. A disadvantage with this laying method is that considerable skill is required to lay the stone elements such that a level finish is obtained, particularly when the stone elements are of small size. Crazy paving when installed by a skilled stonemason can cost in excess of $200.00 per square metre. Even greater skill is required and greater costs incurred if the elements themselves are of different shapes and sizes and a complex pattern is to be laid.

Another disadvantage with the traditional laying method is that it is not usually possible to obtain differences in mortar colouring over the whole job, and such variation in mortar colouring may be desired for aesthetic reasons.

A still further disadvantage is that it is effectively impossible to utilize these traditional methods in forming decorative stone finishes on vertical surfaces.

In an endeavour to reduce the dependence on a skilled stonemason to install natural looking “crazy paving” stone paving surfaces, it has been proposed to form a large tile element measuring one metre square by pouring a cementitious grout into a shallow square tray and then pushing natural rocks or stone fragments into the upper surface of the grout and then allowing the tile element to set. When removed from the mould the tile element was then cut by a diamond saw into four tiles each measuring 500 mm×500 mm. The tiles were marked on the rear faces to enable an installer to align correctly abutting tile edges to maintain the original layout of rocks or stone fragments.

Although generally suitable for its intended purpose, this method of manufacturing “crazy paving” tiles suffered from two major disadvantages. Firstly, it was difficult to maintain an even paving surface due to variations in thickness both within a tile element and also between adjacent tiles of other tile elements.

Secondly, but more importantly, the major problem with these tiles was that even when grouted, the linear intersections between adjacent tiles were clearly visible which prevent the natural look of crazy paving installed by a stonemason.

Another proposal comprised a file element measuring about 750 mm long by about 500 mm wide wherein a plurality of randomly shaped cut stone elements were bonded by an adhesive to a plastics mesh or matting.

The tile elements comprised a shape having a part hexagonal major body portion with parallel sidewalls and minor part hexagonal body ends of a smaller size extending oppositely along a longitudinal axis to form an interlocking tile shape. While generally satisfactory for their intended purpose, the randomly shaped stone elements had to be formed from thin slabs cut to a particular thickness and calibrating the pieces to within a 3 mm variance for each tile. Not only was this a very labour intensive process in the cutting and calibration steps, the thickness variations between adjacent tile elements when laid could vary substantially with a consequent risk of tripping pedestrians walking thereover. Moreover, these tile elements possessed fairly regularly formed peripheral edges such that seams of even width between adjacent tiles were readily discernable.

It is an aim of the present invention to overcome or ameliorate at least some of the disadvantages associated with prior art crazy paving style tiles.

### SUMMARY OF THE INVENTION

According to a first aspect of the invention, there is provided a method of manufacturing an ungrouted composite tile, said method comprising the steps:

(a) placing one or more stone elements on a support surface within a mould cavity having a boundary wall extending about the perimeter thereof;

(b) adding a flowable displacer layer to the mould cavity such that interstices between the stone elements and said support surface are at least partially filled and part of the stone elements protrude above the flowable displacer layer;

(c) overlaying the stone elements and flowable displacer layer to a predetermined depth with a settable material, wherein the settable material binds to the protruding part of the stone elements either directly or after treating the protruding part with an adhesive;

(d) allowing the settable material to cure to form a backing layer;

(e) removing the file from the mould; and

(f) removing the inert displacer from the tile.

The stone elements may be selected from clay, slate, stone or any other natural or synthetic hard material. The stone elements can be a fragment of a larger stone element, or the stone element can have been cut down to size.

The inert displacer can comprise any non-soluble powder or any liquid that is able to exclude the settable material from the gaps between the stone element and mould, and is able to be removed from the gaps after the backing layer has cured. Preferably, the non-soluble powder is a fine powder such as talcum powder, pulverised lime-or fine sand. Preferably, the liquid is a viscous liquid such as a synthetic or mineral oil, water gel, an aqueous polymeric material, an aqueous cellulosic gel, or the like.

It is important that there is good bonding between the stone element and the settable material. Whether or not an adhesive is used to treat the protruding part of the stone element will depend on the nature of the settable material. If the settable material comprises a cementitious mixture (such mixtures being well-known to persons skilled in the art), then an adhesive may first be applied to the stone material prior to overlaying with the settable material. The adhesive can comprise a bonding agent such as an epoxy resin or a cementatious material including one or more polymeric bonding agents.

In one form of the invention, epoxy resin can be applied to the protruding part of the stone element together with cement powder, prior to adding settable material comprising a cementitious mixture. The cement powder helps bond the stone element to the settable material.

In another form of the invention, the settable material can comprise a cementitious mixture containing a polymeric bonding agent.

Preferably the polymeric bonding agent confers a degree of resilience to the settable material to accommodate differing coefficients of thermal expansion between stone elements and the settable material.

In yet another form of the invention, cement can be excluded from the settable material altogether and replaced with a bonding agent such as an epoxy resin or flexible cementitious glue, preferably mixed together with inert filler. Such fillers are well known in the art. An advantage of excluding cement from the settable material is that the tile will be more lightweight.

Suitably the settable material may include a fibrous reinforcing such as fibreglass, metal, or synthetic fibre mesh, enlarged end fibres or any combination thereof.

The tile can be removed from the mould by straighfforward inversion of the mould. However, any other suitable means of removing the tile from the mould can be used, i.e., a demountable mould.

The inert displacer can be removed from the cavities by suction, by brushing or by washing/blasting the tile with a liquid or gas jet. Preferably, the inert displacer is collected for reuse.

The inert displacer enables an ungrouted tile to be manufactured, thus allowing the consumer the choice of texture and grout colour when the tile is laid.

The mould may be of any suitable shape such as a triangle, rectangle, pentagon, hexagon, etc.

Alternatively, the mould may be of an irregular shape which allows interlocking of tile formed therein.

If required, the mould comprises one or more spigot-like projections on a pair of adjacent edges with corresponding socket-like recesses on respective opposite edges.

The mould may contain a stencil such that stone elements can be arranged in accordance with a predetermined pattern.

A projection system, as described elsewhere in this specification, can be used to assist in marking, cutting and arranging stone elements in accordance with a pattern or stencil.

According to another aspect of the invention, there is provided an ungrouted composite tile when made by the above method.

The stone element can comprise clay, slate, stone or any other natural or synthetic hard material straight cut or water washed. Preferably, the tile has a plurality of stone elements. The stone elements can be of varying thickness. The stone elements can be arranged in accordance with a particular pattern.

The inert displacer can comprise a non-soluble powder and is preferably talcum powder, pulverised lime or fine sand.

Alternately, the inert displacer can comprise a viscous liquid such as oil.

In a first embodiment, the backing layer can comprise a cured cementitious mixture, and the adhesive can comprise an polymeric resin and cement powder.

In a second embodiment, the backing layer can comprise cured cementitious mixture containing set polymeric resin.

In a third embodiment, the backing layer can comprise at least set polymeric resin, and preferably further has an appropriate filler.

Preferably, the tile is substantially rectangular or square when viewed in plan and has a surface area of about one by two metres, or one by one metre.

In a still further embodiment of the invention, there is provided an ungrouted composite tile of substantially uniform thickness comprising:

a backing layer; and,

a plurality of stone elements, a part of each stone element being bound either directly or indirectly to the backing layer.

According to a further aspect of the invention, there is provided a method of manufacturing an ungrouted composite file, said method comprising the steps:

(a) placing a plurality of stone elements of substantially identical thickness within a mould;

(b) adding a layer of inert displacer material to the mould such that gaps between the stone elements and mould are at least partially filled and a part of each stone element protrudes above the inert displacer material;

(c) adhering a backing layer to the protruding parts of the stone elements;

(d) removing the tile from the mould; and

(e) removing any inner displacer material from the tile.

The inner displacer can be as described for the other aspects of the invention. The backing layer can be adhered with a polymeric material such as polyurethane or epoxy resin.

Preferably, the backing layer comprises stiff synthetic mesh.

According to yet another aspect of the invention, there is provided a ungrouted composite file comprising:

a plurality of stone elements of substantially identical thickness;

a backing layer adhered to each of the stone elements; and

removable inert displacer between adjacent the stone elements.

The inert displacer, the adhesive and backing layer can be as described for the fifth aspect of the invention.

According to a still further aspect of the invention, there is provided a projection system enabling a stone element to be easily marked for cutting, said projection system comprising:

a first surface region;

a second surface region; and

image projection means, such as a projection camera positioned to project an image of a pattern from the first surface region to the second surface region, wherein the image is projected onto a stone element placed on the second surface region.

Preferably, the first and second surface regions extend horizontally and the projection camera is positioned above the surface regions. More preferably, the surface regions are at different heights to one another.

The projection camera can comprise any suitable projection camera known to persons skilled in the art.

The pattern may be that of a stencil, and the stencil can be located within a pan. The projection system thus enables stone elements to be easily marked for cutting, and after cutting, to be placed within the pan according to the stencil. In this way, persons other than experienced stonemasons can readily produce complex arrangements of stone elements.

According to an alternative aspect of the invention, there is provided a method of enabling stone elements to be easily marked for cutting and to be arranged in accordance with a pattern, said method comprising the steps:

(a) projecting an image of a pattern from a first surface region to a second surface region using image projection means, such as a projection camera;

(b) placing stone elements under the projected image, marking and cutting the stone elements to accord with the image; and

(c) arranging the cut stone elements on the pattern.

Preferably, the pattern is that of a stencil and the stencil can be located within a mould. In this way, inexperienced stonemason can mark, cut and arrange stone elements according to complex patterns.

According to another aspect of the invention there is provided a tile for seamless paving structures, said tile comprising:

a plurality of irregularly shaped stone elements extending at least partially above a backing layer or base, said tile when in aligned abutting relationship with an adjacent tile, forming together with said adjacent tile an irregularly shaped cavity extending between adjacent stone elements whereby, in use, a grouted joint between adjacent tiles extends irregularly on each side of a joint between said backing layer or base to form an optically seamless joint.

If required, edges of said stone elements may extend up to edges of said backing layer or base.

Alternatively, said edges of said backing layer or base may extend beyond edges of adjacent stone elements bonded thereto.

The backing layer or base may be of any suitable shape including rectangular, regular polygon or an irregular shape nestable with adjacent tiles of the same or differing shapes.

Preferably, the tile comprises one or more spigot-like projections extending from opposite or adjacent edges and corresponding socket-like recesses on respective opposite or adjacent edges.

The backing layer or base may comprise a rigid material to which said stone elements are secured.

Alternatively, the backing layer or base may comprise a flexible material to which said stone elements are secured.

The backing layer or base may comprise a cementations composition with or without a polymeric bonding agent.

Suitably said backing layer or base comprises a polymeric composition.

Preferably said backing layer or base comprises reinforcing material.

If required, said backing layer or base comprises an apertured sheet like material.

Preferably, said backing layer comprises a plastics mesh.

The reinforcing material may be selected from chopped fibres with or without enlarged ends, woven or non-woven fibrous matting or a metal or plastics mesh.

Preferably said tile is formed whereby normally exposed surfaces of stone elements comprising said tile lie in a substantially common place.

Most preferably said tile is formed with a substantially constant thickness whereby normally exposed surfaces of stone elements of adjacent tile lie in a substantially common plane.

Accordingly to still another aspect of the invention there is provided a method for manufacture of tiles for seamless paving structures, said method comprising the steps of:

securing to respective opposite surfaces of said stone elements a backing layer or base having a mounting surface substantially parallel to said support surface, said method characterized in that said irregularly shaped stone elements of each said tile are positioned relative to each other whereby non-linear tile boundaries are formed such that, in use, a grouted joint between adjacent tiles extends irregularly on each side of a joint between respective backing layers or bases to form an optically seamless joint.

Suitably said mounting surface is positioned at a predetermined distance from said support surface to form a tile of predetermined thickness.

If required said backing layer or base may comprise an apertured sheet-like material.

Suitably said backing layer or base is comprised of a flexible material.

Preferably said backing layer or base comprises a mesh-like material.

Suitably said stone elements are secured to a substrate or predetermined shape and/or thickness.

If required said backing layer or base may comprise a pre-formed member securable to said stone elements by an adhesive.

Alternatively said backing layer or base may comprise a flowable castable material adhesively secured to said stone elements.

If required said backing layer or base may be formed in a mould having an upright boundary wall.

The tile may be formed by placing a plurality of irregularly shaped stone elements onto the surface of a flowable castable material supported on a substantially planar support surface within a predetermined boundary shape and compressing said stone elements into said castable material by a substantially planar compression member lying in a plane substantially parallel to said support surface.

Alternatively said irregularly stone elements may be placed on a substantially planar support surface within a predetermined boundary shape and thereafter applying a layer of a flowable castable material over said stone elements to form a backing layer or base of predetermined thickness having a mounting surface substantially parallel to said support surface.

Suitably said stone elements are located on a support surface within an upright boundary wall.

If required, a flowable displacement material may be introduced into interstices between adjacent stone elements to form grout channels therebetween.

The invention also provides a method for installing tiles for seamless paving structures, said method including the steps of:

adhering said tiles to a planar surface in aligned abutment; and,

introducing a grouting composition into cavities between adjacent stone elements whereby said grouting composition in the region of a joint between adjacent tiles extends irregularly over each side of said joint to form a substantially optically seamless joint.

If required, said tiles may be laid on said surface with abutting base edges.

Alternatively, said base edges may be spaced and stone elements of differing sizes are inserted into the surface of grout therebetween to form an optically seamless joint.

Although described herein with reference to paving tiles, it should be understood that the expression “paving tiles” also includes decorative panels for other surfaces including upright wall surfaces and the like.

The term “comprise”, or variations of the term such as “comprises” or “comprising”, are used herein to denote the inclusion of a stated integer or stated integers but not to exclude any other integer or any other integers, unless in the context or usage an exclusive interpretation of the term is required.

### BRIEF DESCRIPTION OF THE DRAWINGS

Preferred embodiments of the invention will now be described with reference to the following drawings in which:

FIG. 1 is a flow diagram representing the steps in manufacturing an ungrouted composite tile, according to an embodiment of the present invention;

FIG. 2 is a transverse cross-sectional view of an ungrouted composite tile made by the method of FIG. 1;

FIG. 3 shows a transverse cross-sectional view of the tile of FIG. 2 when laid;

FIG. 4 shows a perspective view of a projection system according to another embodiment of the present invention;

FIG. 5 shows a tile for seamless paving structures;

FIG. 6 shows a partial view of a seamless paving structure formed with the tiles of FIG. 5; and

FIG. 7 shows a partial cross-sectional view of a grouted joint between adjacent tiles.

FIG. 8 shows schematically an alternative method of producing paving tiles according to the invention.

FIG. 9 shows a part cross-sectional view of a grouted tile installation.

FIG. 10 shows an alternative method of installation of the tiles of FIG. 9.

FIG. 11 shows yet another method of manufacture of paving tiles according to the invention.

FIG. 12 shows the installation of circular paving tiles according to the invention.

### DETAILED DESCRIPTION OF THE INVENTION

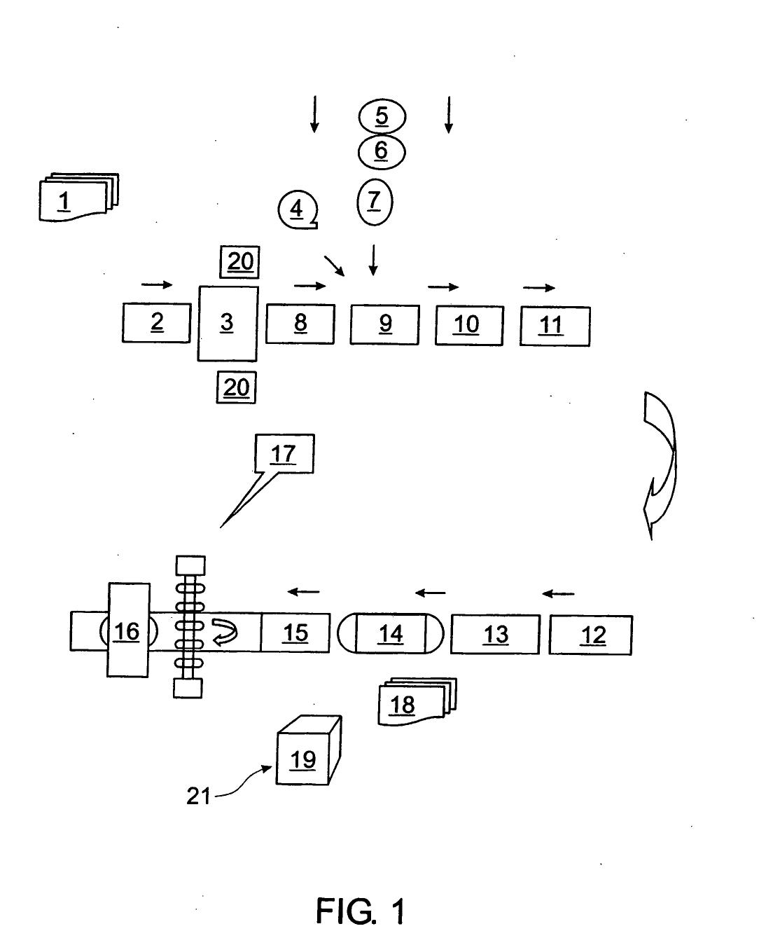

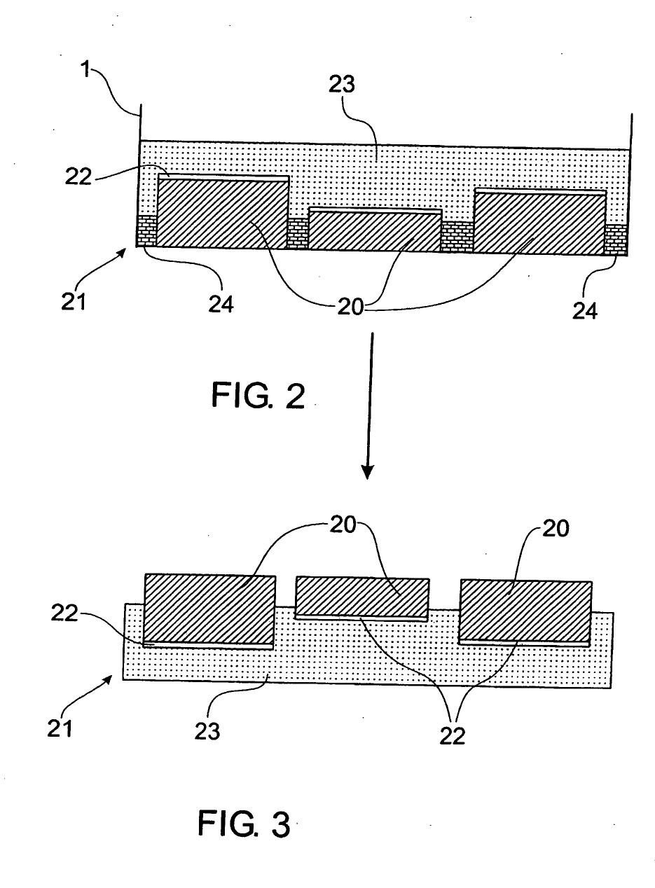

FIG. 1 is a flow diagram representing the steps in manufacturing an ungrouted composite tile, such as the tile 21 shown in FIGS. 2 and 3. Numerals 2-19 are shown only in FIG. 1.

A shallow mould or pan 1, having a base area of 500 mm×500 mm is placed on a conveyor belt 2 sprayed with a release agent such as form oil and transported to a layup station 3. Once the pan 1 reaches the layup station 3, stone elements (such as slate) 20 are arranged within the pan 1 to achieve a random pattern.

The stone elements 20 may either be cut to size but preferably randomly shaped fragments of stone are simply fitted into the pan 1 to achieve a random pattern. The stone elements 20 are spaced slightly apart from one another, and the preferred face of each stone element 20 is placed face down within the pan 1.

Once the stone elements 20 have been arranged within the pan 1, the pan 1 is conveyed to an applicator 8 that adds an inert displacer 24, typically talcum powder or fine sand, to the pan 1 such that interstices between adjacent stone elements 20 and the pan 1 are to some extent filled with the displacer 24 (see FIG. 2). The displacer 24 is removed prior to laying of the tile and creates an ungrouted tile 21, as evident from FIGS. 2 and 3.

Applicator 8 also applies a coat of adhesive 22, typically epoxy resin or cement powder plus bonding agent, to the exposed surface of each stone element 20 (see FIG. 2). The adhesive layer 22 helps bond each stone element 20 to a subsequently added settable material which forms a backing layer 23.

The stone elements 20 and displacer 24 are then overlayed with the backing layer 23 comprising settable cementitious material (see FIG. 2). The backing layer 23 is excluded from the spaces filled with displacer 24. The backing layer 23 is dispensed (at numeral 9) from a bowl mixer 7 that contains a mixture of and (from said hopper 5), cement (from cement hopper 6), polystyrene beads, calcium chloride, water as well as other well known ingredients (at numeral 4).

The backing layer 23 is quite lightweight, it holds the stone elements 20 together, and enables the tile 21 to be made to a precise and uniform thickness.

When the tiles have cured they are removed from respective pans and the empty pans 18 are reused in the manufacture of other tiles.

The displacer 24 produces an ungrouted tile 19,21 which allows the consumer the choice of texture and colour of grout 25 when laid as shown in FIG. 3. Moreover, laying a composite tile 21 is much less difficult than laying individual stone elements.

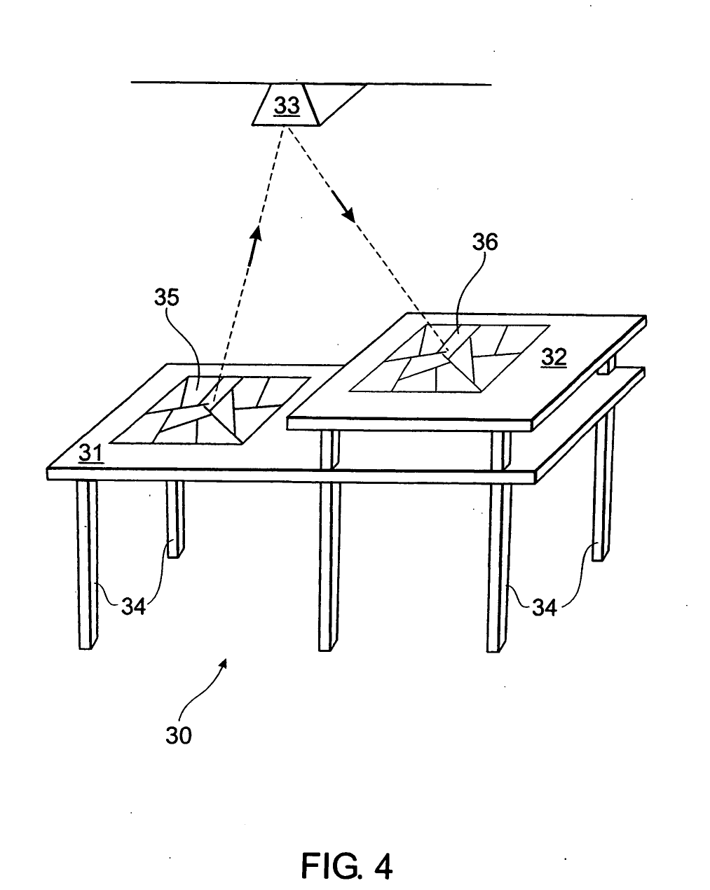

FIG. 4 shows details of a projection system 30 to enable stone elements to be easily marked for cutting and to be arranged in accordance with a complex predetermined pattern 35.

The projection system 30 has a first surface region 31, a second surface region 32 at a different height to the first surface region 31, and a projection camera 33 positioned above the surface regions 31, 32. The surface regions 31, 32 are supported above the ground by legs 34. The projection camera 33 is positioned to project an image 36 of the pattern 35 placed on the first surface region 31 to the second surface region 32.

The pattern can be an artistic work, a stencil, or even another composite tile, the pattern of which is to be reproduced. The pattern can be located within a pan for easy arrangement of the stone elements.

The image 36 is projected onto a stone element (not shown) placed on the second surface region 32. The stone element is then marked and cut. After cutting, the stone element is fitted to the pattern 35, much like fitting a jigsaw puzzle. In this way, stone elements can be easily marked, cut and arranged by persons other than experienced stonemasons.

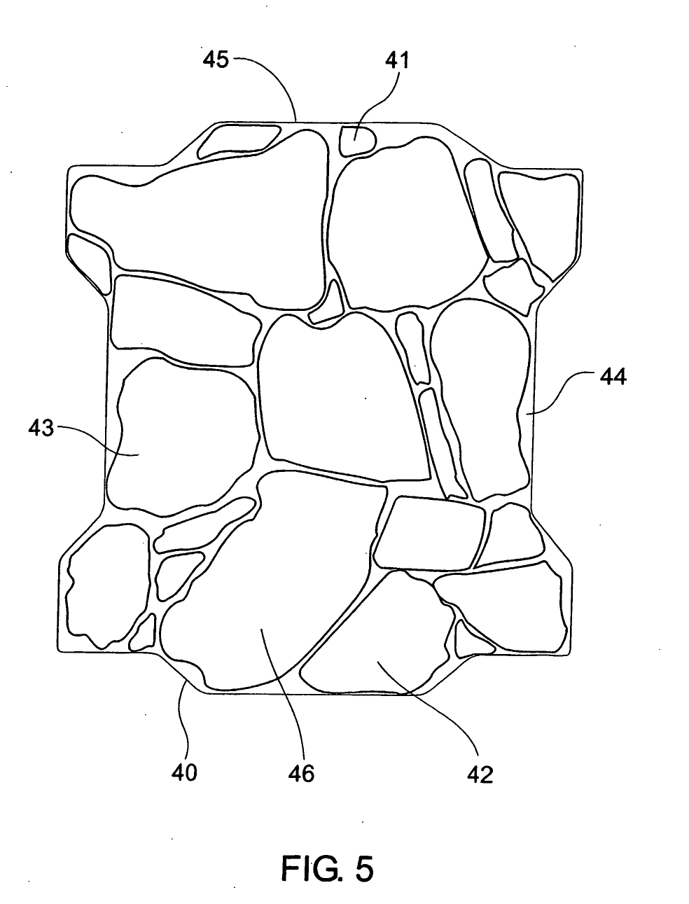

FIGS. 5-7 illustrate the manner in which optically seamless joints are obtained between adjacent tiles.

FIG. 5 shows a plan view of a tile 40 made in accordance with the invention. The tile is laid up in an irregularly-shaped mould 40a to obtain an ungrouted tile as shown having non-linear edges represented by spigot-like projections 41, 42 on opposite edges of the tile and corresponding socket-like recesses 43, 44 on the adjacent opposite edges.

When the tiles are laid with the edges 45a of the tile bases 45 of adjacent tiles in contact with each other, respective socket-like recesses 43,44 nestingly accommodate spigot-like projections 41,42.

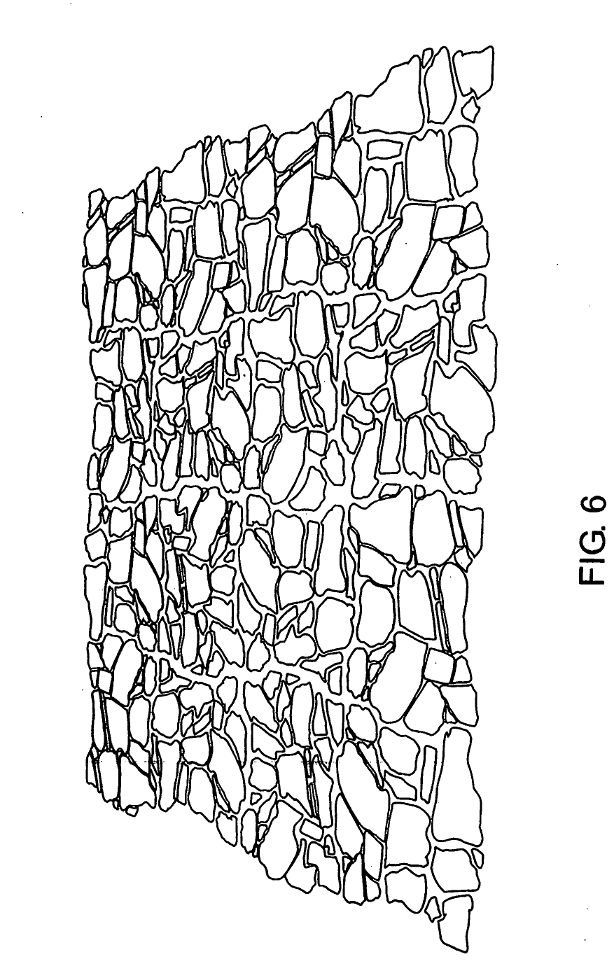

Because there are in effect no sharp straight lines visible at the joints between adjacent tiles and the width of the grout varies in a manner similar to the variable grout width between adjacent stone elements 46, the joints effectively become optically invisible as shown in FIG. 6.

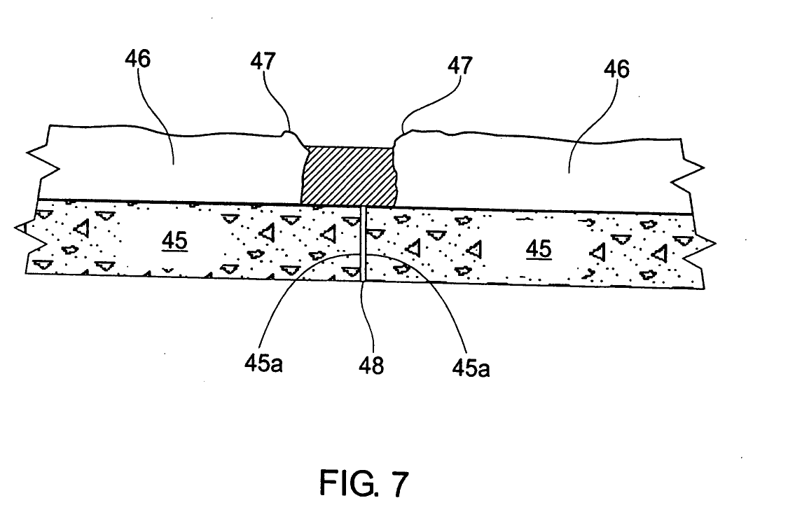

As shown in FIG. 7, because of the irregular shapes and random patterns obtained when stone elements 46 are laid up in the mould, the upper edges of the tiles represented by the upper edges 47 of adjacent stone elements 46 are highly irregular and are set back from the smoothly formed base edges in an irregular fashion such that when the tiles are grouted in situ, the grout 50 overlies the joint 48 between adjacent tile bases 45 in a random fashion with a variable width.

Although a rectangular or square tile formed in accordance with the invention will produce a non-linear grout interstice between adjacent tiles, it is preferred that the shape of the tile is other than square or rectangular to avoid a partially visible grid-like pattern appearing in large tiled areas. The non-linear edges of the tile shown in FIG. 5 are very effective in avoiding the appearance of joins on a grid-like pattern in large paved areas as shown in FIG. 6.

The files may be formed with one or more spigot-like projections at one pair of opposed ends or sides which are complementary with one or more complimentary socket-like recesses at a second pair of opposed sides or ends to provide a non-linear join between adjacent tiles. Alternatively, the spigot-like projections may be on one pair of adjacent ends or sides, and the socket-like recesses on the other pair of adjacent ends or sides.

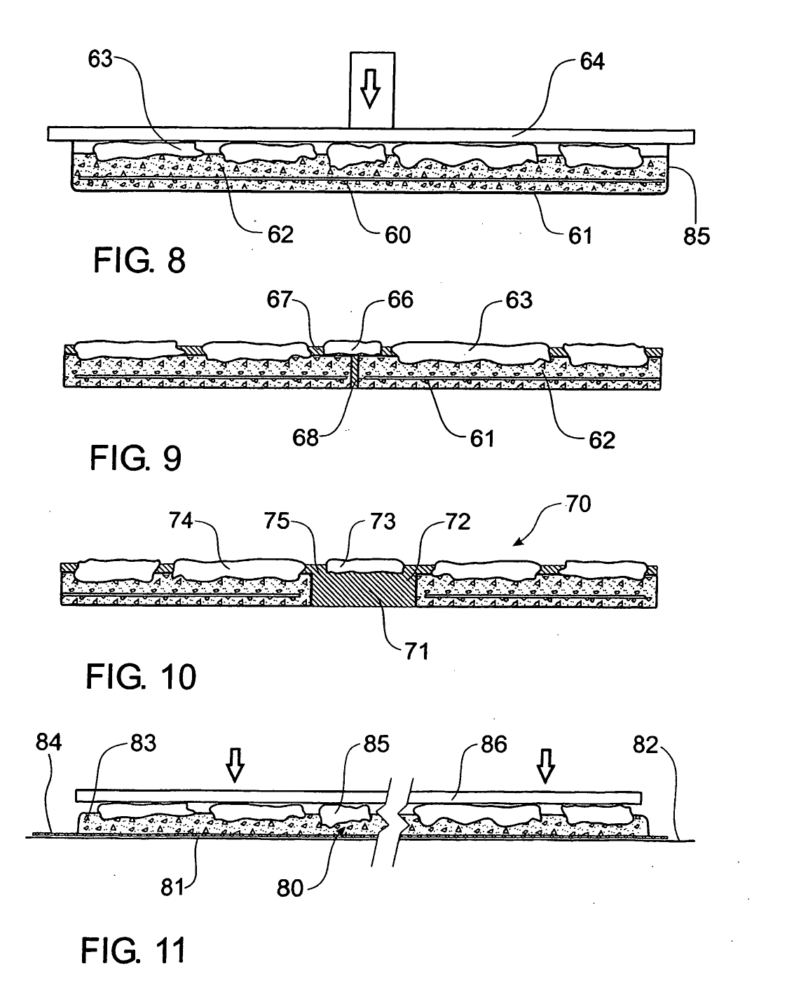

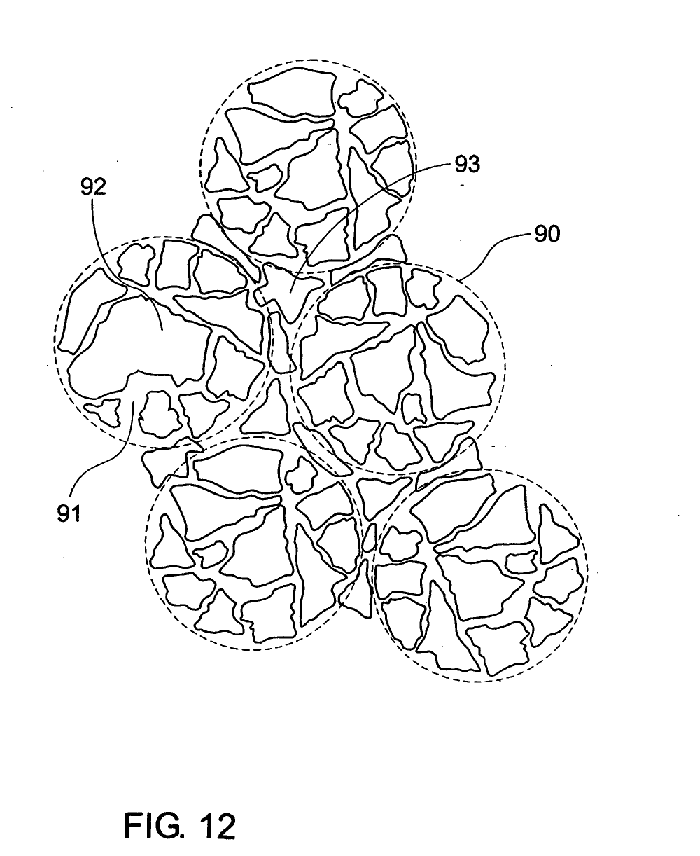

FIG. 8 shows an alternative method of manufacture of tiles according to the invention.

A layer of plastics reinforcing mesh 60 is placed in a moulding tray 61 and a layer of cementatious material 62 is placed in the tray. A plurality of stone pieces 63 of variable thickness or of the same thickness are laid out on the surface of the uncured material 62 and thereafter a planar platen 64 is urged into contact with stone pieces 63 which are pushed into the semi-fluid material 62. When platen 64 comes into contact with the boundary wall 65 of tray 61 a tile on constant thickness with a generally planar upper surface is formed.

FIG. 9 shows the installation of tiles made according to FIG. 8 wherein if required, further small stone pieces 66 may be pushed into the uncured grout 67 overlying the joint 68 to obtain an optically seamless joint between adjacent tiles.

FIG. 10 shows an alternative installation method wherein square or rectangular files 70 made in accordance with the invention can be effectively employed if a gap 71 of about 50 mm or more is left between adjacent tiles. When the tiles 70 are grouted in situ, the region 72 between the adjacent tiles can have irregularly-shaped stone elements 73 pushed into the surface of the wet grout 75 using the adjacent stone elements 74 of the tiles as a guide to obtain an even thickness.

As an alternative to spacing the tiles, the tiles may be formed with the stone elements set back about 25 mm from the edge of the tile bases as shown in FIG. 11. This enables the tiles to be accurately abutted while still providing a wide grout channel over a tile joint to accommodate irregularly-shaped stone elements after the tiles are grouted. In this embodiment, the paving tile 80 is formed by placing a plastics mesh reinforcing pad 81 of desired shape onto a planar support surface 82. A layer of flowable curable cementatious material 83 is spread more or less evenly over the major part of the pad 81 leaving the edge regions 84 exposed. Thereafter stone pieces 85 are placed on the surface of the layer of cementatious material 81 and on planar platen 86 is urged into contact with stone pieces 85 to form a tile of even thickness to a predetermined depth and wherein the exposed upper surfaces of stone pieces 85 are in a planar substantially parallel to the support surface 88.

With appropriate modifications to the embodiment hereinbefore described, it is possible to manufacture a grouted tile.

The inert displacer is substituted by a layer of chemical grout retarder of known type over which is placed a layer of grout, preferably to the full depth of the adjacent stone elements. A plastics or metal mesh may be secured to the exposed stone surfaces by adhesive.

The retarder significantly slows the setting rate of the normally uppermost layer of the grout by from 24-36 hours. When the composite tile is removed from the mould, the unset/partially set top grout layer can be removed, e.g., by pressurised water to leave the remaining grout (e.g., to a depth of 50-80% of the thickness of the stone elements) in the interstices between the adjacent stone elements.

In a further alterative embodiment, the stone elements may be pressed into the grout. For example, a layer of retarder is placed over the bottom of the mould and a layer of grout is superimposed over the retarder. The stone elements can be placed and pressed into the grout until they contact the base of the mould whereby the grout is “extruded” into the interstices between adjacent stone elements.

The settable material with or without a reinforcing mesh, is applied and cures to form the backing layer. When the composite tile is removed from the mould, the unset/partially set grout is removed to expose the top faces of the stone elements (and the grout between the stone elements).

It readily will be apparent to a skilled addressee that many modifications and variations may be made to the invention without departing from the spirit and scope thereof.

For example, the tiles may be triangular, polygonal or even circular in shape and yet still achieve an optically seamless joint between adjacent tiles.

As shown schematically in FIG, 12 circular tiles 90 made in accordance with any of the aforesaid methods are secured on a surface using a polyurethane or other durable polymeric adhesive resistant to weathering. After grouting the interstices 91 between adjacent stone pieces 92, irregularly shaped stone pieces 93 are pressed into the wet grout in the regions between adjacent tiles whereby an optically seamless finish is obtained.

Decorative panels for upright surfaces such as walls, columns and the like are also possible according to the invention. Tiles made in accordance with any of the aforesaid methods may be secured to an upright surface with masonry anchors of a known type in conjunction with a durable polymeric adhesive and thereafter the interstices may be grouted to form an optically seamless finish.

1. A tile for seamless paving structures, said tile comprising:
a plurality of irregularly shaped stone elements extending at least partially above a backing layer or base, said tile when in aligned abutting relationship with an adjacent tile, forming together with said adjacent tile an irregularly shaped cavity extending between adjacent stone elements whereby, in use, a grouted joint between adjacent tiles extends irregularly on each side of a joint between said backing layer or base to form an optically seamless joint.

2. A tile as claimed in claim 1 wherein respective edges of said stone elements extend up to edges of said backing layer or base.

3. A tile as claimed in claim 1 wherein respective edges of said backing layer or base extend beyond edges of adjacent stone elements bonded thereto.

4. A tile as claimed in claim 1 wherein said backing layer or base is selected from any suitable shape including rectangular, regular polygon or an irregular shape nestable with adjacent tiles of the same or differing shapes.

5. A tile as claimed in claim 1 comprising a rectangular backing layer or base having one or more spigot-like projections extending from opposite or adjacent edges and corresponding socket-like recesses or respective opposite or adjacent edges.

6. A tile as claimed in claim 1 wherein said backing layer or base comprises a rigid material to which said stone elements are secured.

7. A tile as claimed in claim 1 wherein said backing layer or base comprises a flexible material to which said stone elements are secured.

8. A tile as claimed in claim 1 wherein said backing layer or base comprises a cementatious composition with or without a polymeric bonding agent.

9. A tile as claimed in claim 1 wherein said backing layer or base comprises a polymeric composition.

10. (canceled)

11. (canceled)

12. A tile as claimed in claim 1 wherein said backing layer or base comprises a plastics mesh.

13. (canceled)

14. A tile as claimed in claim 1 wherein said tile is formed whereby normally exposed surfaces of stone elements comprising said tile lie in a substantially common plane.

15. (canceled)

16. A method for manufacture of tiles for seamless paving structures said method comprising the steps of:
supporting on a substantially planar support surface, a plurality of irregularly shaped stone elements with a normally exposed surface of said stone elements being in contact with said support surface; and,
securing to respective opposite surfaces of said stone elements a backing layer or base having a mounting surface substantially parallel to said support surface, said method characterized in that said irregularly shaped stone elements of each said tile are positioned relative to each other whereby non-linear tile boundaries are formed such that, in use, a grouted joint between adjacent tiles extends irregularly on each side of a joint between respective backing layers or bases to form an optically seamless joint.

17. A method as claimed in claim 16 wherein said mounting surface is positioned at a predetermined distance from said support surface to form a tile of predetermined thickness.

18. (canceled)

19. A method as claimed in claim 16 wherein said stone elements are secured to a mesh substrate.

20. A method as claimed in claim 16 wherein said backing layer or base is formed by a flowable castable material adhesively securable to said stone elements.

21. A method as claimed in claim 16 wherein said backing layer or base is formed in a mould having an upright boundary wall.

22. (canceled)

23. (canceled)

24. (canceled)

25. A method as claimed in claim 16 wherein a flowable displacement material is introduced into interstices between adjacent stone elements before formation of a backing layer or base thereover to form grout channels therebetween.

26. A method for installing tiles for seamless paving structures, said method including the steps of:
adhering to a planar surface in aligned abutment adjacent tiles according to claim 1; and,
introducing a grouting composition into cavities between adjacent stone elements whereby said grouting composition in the region of a joint between adjacent tiles extends irregularly over each side of said joint to form a substantially optically seamless joint.

27. A method of installing tiles according to claim 26 wherein said tiles are laid on said surface with abutting base edges.

28. A method as claimed in claim 26 wherein said base edges are spaced and stone elements of differing sizes are inserted into the surface of grout therebetween to form an optically seamless joint.
